(19) United States
(12) Patent Application Publication
(10) Pub. No.: US 2020/0220219 A1
(43) Pub. Date: Jul. 9, 2020

(54) ELECTROSPUN COMPOSITE SEPARATOR FOR ELECTROCHEMICAL DEVICES AND APPLICATIONS OF SAME

(71) Applicants: Ford Cheer International Limited, Road Town (VG); The Regents of the University of California, Oakland, CA (US)

(72) Inventors: Jimmy Wang, Monrovia, CA (US); Li Shen, Los Angeles, CA (US); Chen Zhang, Los Angeles, CA (US)

(21) Appl. No.: 16/822,343

(22) Filed: Mar. 18, 2020

Related U.S. Application Data
(63) Continuation-in-part of application No. 15/888,223, filed on Feb. 5, 2018.
Application No. 15/888,223 is a continuation-in-part of application No. 15/888,232, filed on Feb. 5, 2018.
Application No. 15/888,232 is a continuation-in-part of application No. 16/369,031, filed on Mar. 29, 2019.
Application No. 16/369,031 is a continuation-in-part of application No. 16/787,247, filed on Feb. 11, 2020.
(60) Provisional application No. 62/821,539, filed on Mar. 21, 2019.
(60) Provisional application No. 62/455,752, filed on Feb. 7, 2017.
(60) Provisional application No. 62/455,800, filed on Feb. 7, 2017.
(60) Provisional application No. 62/455,752, filed on Feb. 7, 2017.
(60) Provisional application No. 62/455,800, filed on Feb. 7, 2017.
(60) Provisional application No. 62/650,580, filed on Mar. 30, 2018.
(60) Provisional application No. 62/650,623, filed on Mar. 30, 2018.
(60) Provisional application No. 62/803,725, filed on Feb. 11, 2019.

(51) Int. Cl. H01M 10/0567; H01M 10/0525; H01M 10/0565; H01M 10/42

(52) U.S. Cl. CPC H01M 10/0567; H01M 10/4235; H01M 10/0565; H01M 10/0525

(57) ABSTRACT

The invention provides a composite separator and an electrochemical device such as a battery with the composite separator. The composite separator includes a membrane comprising at least one polymer and at least one metal organic framework (MOF) material defining a plurality of pore channels, where the at least one MOF material is activated at a temperature for a period of time. The at least one MOF material is a class of crystalline porous scaffolds constructed from metal clusters with organic ligands and comprises unsaturated metal centers, open metal sites and/or structural defects that are able to complex with anions in electrolyte. The membrane is formed by electrospinning of a mixture of the at least one MOF material with a polymer solution comprising the at least one polymer dissolved in at least one solvent, such that the membrane has a porous structure with tunable pore sizes and bead-threaded fibrous morphology.

### CROSS-REFERENCE TO RELATED PATENT APPLICATIONS

This application claims priority to and the benefit of U.S. provisional patent application Ser. No. 62/821,539, filed Mar. 21, 2019.

This application is also a continuation-in-part application of U.S. patent application Ser. No. 16/787,247, filed Feb. 11, 2020, which claims priority to and the benefit of U.S. provisional patent application Ser. No. 62/803,725, filed Feb. 11, 2019.

This application is also a continuation-in-part application of U.S. patent application Ser. No. 16/369,031, filed Mar. 29, 2019, which itself claims priority to and the benefit of U.S. provisional patent application Ser. Nos. 62/650,580 and 62/650,623, both filed Mar. 30, 2018.

This application is also a continuation-in-part application of U.S. patent application Ser. No. 15/888,223, filed Feb. 5, 2018, which claims priority to and the benefit of U.S. provisional patent application Ser. Nos. 62/455,752 and 62/455,800, both filed Feb. 7, 2017.

This application is also a continuation-in-part application of U.S. patent application Ser. No. 15/888,232, filed Feb. 5, 2018, which claims priority to and the benefit of U.S. provisional patent application Ser. Nos. 62/455,752 and 62/455,800, both filed Feb. 7, 2017.

Each of the above-identified applications is incorporated herein by reference in its entirety.

### FIELD OF THE INVENTION

This invention relates generally to batteries, and more particularly, to an electrospun composite separator comprising porous metal-organic frameworks (porous coordination solids) and its application in electrochemical devices such as batteries, where the metal-organic frameworks contain functionalities to immobilize the anions in binary electrolytes, affording significant improvements in ion transportation and battery performances.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

There are increasing demands for high-performance lithium-ion batteries for electric vehicles, microelectronics, and other applications. Such electrochemical devices are operated through charge separation in one electrode, transport of ions and electrons respectively through the electrolyte and the external circuit, and recombination of the electrons and ions in the other electrode. The transport kinetics of the electrons and ions dominates the rate performance of the devices.

In lithium-ion batteries, anions in the electrolytes generally do not participate in the lithiation reactions while exhibit higher mobility compared with that of lithium ions, resulting in a low Li⁺ transference number (t_{Li}⁺). A low t_{Li}⁺ gives rise to concentration polarization, reduces energy efficiency, and causes side reactions and joule heating, which can shorten the cycling life especially under fast charging/discharging condition. The separators in lithium-ion batteries serve as reservoirs for electrolytes, which mediate the transport of ions and can significantly impact the battery performances. Extensive efforts have been made to afford the separators with various functionalities, such as the abilities to suppress the proliferation of lithium dendrites, mitigate the crossover of polysulfides, and improve the thermal stability of the separators. For instance, separators containing hydrophilic polymers or ordered nanoscale structure were developed, leading to improved electrolyte affinity and mitigated formation of dendrites. Graphene and metal oxides were also coated on separators, which mitigates the shuttling effect of polysulfides in lithium-sulfur batteries. Fire-resistant moieties such as hydroxyapatite and polyimide were also used to mitigate the flammability concerns. Ceramic particles such as SiO₂, Al₂O₃, and ZrO₂, were also incorporated into polyolefin separators, leading to improved wettability with electrolytes, thermal stability and mechanical modulus. Such modified separators, however, still lack the ability to modulate the ion-transport process resulting in a low t_{Li}⁺.

Hence, regulating ion transport behaviors with both high Li⁺ conductivity and high t_{Li}⁺ requires an efficient functional component in a separator to immobilize anions while promote Li⁺ transport.

### SUMMARY OF THE INVENTION

This invention, in one aspect, relates to a composite separator used for an electrochemical device, comprising a membrane comprising at least one polymer and at least one metal organic framework (MOF) material defining a plurality of pore channels, wherein the at least one MOF material is activated at a temperature for a period of time. The at least one MOF material is a class of crystalline porous scaffolds constructed from metal clusters with organic ligands and comprises unsaturated metal centers, open metal sites and/or structural defects that are able to complex with anions in electrolyte. The membrane is formed by electrospinning of a mixture of the at least one MOF material with a polymer solution comprising the at least one polymer dissolved in at least one solvent, such that the membrane has a porous structure with tunable pore sizes and bead-threaded fibrous morphology.

In one embodiment, the organic ligands comprise benzene-1,4-dicarboxylic acid (BDC), benzene-1,3,5-tricarboxylic acid (BTC), biphenyl-4,4′-dicarboxylic acid (BPDC), or their derivatives, and the metal clusters comprise magnesium (Mg), Aluminium (Al), Titanium (Ti), Vanadium (V), Chromium (Cr), Manganese (Mn), Iron (Fe), Cobalt (Co), Nickel (Ni), Copper (Cu), Zinc (Zn), or Zirconium (Zr).

In one embodiment, the at least one MOF material comprises HKUST-1, MIL-100-Al, MIL-100-Cr, MIL-100-Fe, UiO-66, UiO-67, PCN series, MOF-808, MOF-505, MOF-74, or their combinations.

In one embodiment, the BDC ligand is replaceable by 2-amino-benzenedicarboxylic acid (H₂N-H₂BDC), 2-nitro-benzenedicarboxylic acid (O₂N-H₂BDC), 2-bromo-benzenedicarboxylic acid (Br-H₂BDC), or terephthalate-based linkage ligands.

In one embodiment, the at least one polymer comprises silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof, or their combinations.

In one embodiment, the at least one solvent comprises acetone, water, methanol, ethanol, acetic acid, dimethylformamide (DMF), acetone, water, methanol, ethanol, acetic acid, dimethylformamide (DMF), dimethylacetamide (DMAc), N-Methyl-2-pyrrolidone (NMP), tetrahydrofuran (THF), or their combinations.

In one embodiment, an amount of the MOF material in the composite separator is in a range of about 20-95 wt %.

In another aspect, the invention relates to a method of fabricating a composite separator, comprising providing a suspension mixture to an electrospining apparatus having a metal nozzle, wherein the suspension mixture comprises at least one MOF material dispersed in a polymer solution comprising at least one polymer dissolved in at least one solvent; applying a voltage between the metal nozzle and a collector substrate positioned at a distance from the metal nozzle; extruding the suspension mixture from the metal nozzle at a feeding rate so as to generate electrospun fibers and deposit the generated fibers on the collector substrate to form a mat comprising entangled fibrous networks with a non-woven structure; and hot-pressing the mat into a membrane to form a composite separator.

In one embodiment, the method further comprises heating the membrane was at a temperature under vacuum to prevent rehydration of activated MOF during process.

In one embodiment, the voltage is in a range of about 1-50 kV, the feeding rate is about 1 mL h⁻¹, and the fibers have diameters ranging from tens of micrometers to tens of nanometers, and the composite separator has a thickness that is collectively tuned by the feeding rate and operation time.

In one embodiment, the at least one MOF material comprises HKUST-1, MIL-100-Al, MIL-100-Cr, MIL-100-Fe, UiO-66, UiO-67, PCN series, MOF-808, MOF-505, MOF-74, or their combinations.

In one embodiment, the at least one polymer comprises silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof, or their combinations.

In one embodiment, the at least one solvent comprises acetone, water, methanol, ethanol, acetic acid, dimethylformamide (DMF), acetone, water, methanol, ethanol, acetic acid, dimethylformamide (DMF), dimethylacetamide (DMAc), N-Methyl-2-pyrrolidone (NMP), tetrahydrofuran (THF), or their combinations.

In a further aspect, the invention relates to an electrochemical device, comprising a positive electrode, a negative electrode, an electrolyte disposed between the positive and negative electrodes, and a separator disposed in the electrolyte. The electrolyte is an liquid electrolyte comprising a metal salt dissolved in a non-aqueous solvent. The separator is the composite separator as disclosed above.

In one embodiment, the non-aqueous solvent comprises one or more of ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, and cyclic ether compounds including at least one of tetrahydrofuran, 2-methyltetrahydrofuran, 1,3-dioxolane and dioxane.

In one embodiment, anions in the liquid electrolytes are spontaneously adsorbed by the at least one MOF material and immobilized within the pore channels, thereby liberating metal ions and leading to the metal ions transport with a metal ion transference number higher than that of a separator without the at least one MOF material.

In one embodiment, the metal ions transference number is a ratio of a metal ion conductivity to an ionic conductivity, wherein the ionic conductivity is a total value of the metal ion conductivity and anionic conductivity.

In one embodiment, the metal ion transference number of the liquid electrolytes in the composite separator is in a range of about 0.5-1.

In one embodiment, the metal salt comprises one or more of a lithium salt, a sodium salt, a magnesium salt, a zinc salt, and an aluminum salt.

In one embodiment, the lithium salt comprises one or more of lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, and lithium chloride.

In one embodiment, the sodium salt comprises one or more of sodium trifluoromethanesulfonate, NaClO₄, NaPF₆, NaBF₄, NaTFSI (sodium(I) Bis(trifluoromethanesulfonyl)imide), and NaFSI (sodium(I) Bis(fluorosulfonyl)imide).

In one embodiment, the magnesium salt comprises one or more of magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), and Mg(FSI)₂ (magnesium(II) Bis(fluorosulfonyl)imide).

In one embodiment, the zinc salt comprises one or more of zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide).

In one embodiment, the electrochemical device is a lithium battery, a sodium battery, a magnesium battery, or a zinc metal battery.

In one embodiment, for the lithium battery, the positive electrode comprises one or more of LiCoO₂ (LCO), LiNiMnCoO₂ (NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide including LiNi_{0.8}Co_{0.15}Al_{0.05}O₂ or NCA, lithium vanadium oxide (LiV₂O₅), and Li₂MSiO₄ with M being composed of a ratio of Co, Fe, and/or Mn; and the negative electrode comprises one or more of lithium metal (Li), graphite, hard or soft carbon, graphene, carbon nanotubes, titanium oxide including at least one Li₄Ti₅O₁₂ and TiO₂, silicon (Si), tin (Sn), germanium (Ge), silicon monoxide (SiO), silicon oxide (SiO₂), tin oxide (SnO₂), and transition metal oxide including at least one of Fe₂O₃, Fe₃O₄, Co₃O₄ and MnₓO_{y}.

In one embodiment, the positive electrode comprises one or more of NaMnO₂, NaFePO₄ and Na₃V₂(PO₄)₃ for the sodium battery, one or more of TiSe₂, MgFePO₄F, MgCo₂O₄ and V₂O₅ for the magnesium battery, or one or more of γ-MnO₂, ZnMn₂O₄, and ZnMnO₂ for the zinc battery.

These and other aspects of the present invention will become apparent from the following description of the preferred embodiment taken in conjunction with the following drawings, although variations and modifications therein can be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematic of making a composite separator from electrospinning, according to embodiments of the invention.

FIG. 2 shows schematic of effect of metal-organic frameworks (MOFs) with open metal sites in facilitating the lithium transport, according to embodiments of the invention.

FIG. 3 shows X-ray diffraction patterns of simulated, as-synthesized and activated UiO-66 (porous zirconium terephthalate), according to embodiments of the invention.

FIG. 4 shows N₂ adsorption and desorption isotherms of UiO-66 at 77 K and inset shows DFT pore size distribution, according to embodiments of the invention.

FIG. 5 shows a scanning electron microscopy (SEM) image of synthesized UiO-66, according to embodiments of the invention.

FIG. 6 shows (panel a) a freestanding electrospun MOF-polyvinyl alcohol (PVA) composite membrane (denoted as EMP) and (panel b) a flexible EMP in bend state, according to embodiments of the invention.

FIG. 7 shows SEM images of an EMP, according to embodiments of the invention.

FIG. 8 shows N₂ adsorption/desorption isotherms of EMP. The inset shows the DFT pore size distribution, according to embodiments of the invention.

FIG. 9 shows X-ray diffraction patterns of MOFs particles, electrospun PVA membrane (denoted as EP) and EMP.

FIG. 10 shows Fourier Transform infrared (FTIR) spectroscopy of MOFs particles, electrospun PVA membrane (denoted as EP) and EMP, according to embodiments of the invention.

FIG. 11 shows distribution of Zr element in EMP mapped by energy dispersive x-ray spectroscopy, according to embodiments of the invention.

FIG. 12 shows transmission electron microscope images of EMP, according to embodiments of the invention.

FIG. 13 shows the thermogravimetric analysis curve of UiO-66 in air atmosphere, according to embodiments of the invention.

FIG. 14 shows optical photographs of separators after storage at oven for 1 h, according to embodiments of the invention.

FIG. 15 shows flammability tests for EMP, EP and commercialize polypropylene membrane (denoted as PP), according to embodiments of the invention.

FIG. 16 shows measurement of lithium ion transference number of the electrolyte (1M LiPF₆ in ethylene carbonate/diethyl carbonate, denoted as LP) in EMP, according to embodiments of the invention.

FIG. 17 shows measurement of lithium ion transference number of the electrolyte (LP) saturated PP, according to embodiments of the invention.

FIG. 18 shows measurement of lithium ion transference number of the electrolyte (LP) in composite separator with inactivated UiO-66 (denoted as IEMP), according to embodiments of the invention.

FIG. 19 shows the FTIR of EMP and IEMP, according to embodiments of the invention.

FIG. 20 shows ionic conductivity at various temperatures and activation energy obtained from linear fitting of Arrhenius equation of LP-EMP (LP-imbibed EMP, and so forth), LP-PP, LC-EMP and LC-PP, according to embodiments of the invention.

FIG. 21 shows contact angles of LP-EMP, LP-PP, LC-EMP and LC-PP, according to embodiments of the invention.

FIG. 22 shows cyclic voltammetry curves of SS|electrolyte|Li cells with LP-PP and LP-EMP under a sweep rate of 1 mV s⁻¹ (SS working electrode refers to stainless steel plates, Li is reference electrode), according to embodiments of the invention.

FIG. 23 shows galvanostatic cycling of Li symmetric cells using the electrolyte (LP) saturated electrolyte saturated PP and EMP, according to embodiments of the invention.

FIG. 24 shows the XRD pattern of EMP harvested from cycled and Li|LP-EMP|Li cells (after 200 cycles), according to embodiments of the invention.

FIG. 25 shows Nyquist plots of cycled Li|LP-PP|Li and Li|LP-EMP|Li cells (after 200 cycles), according to embodiments of the invention.

FIG. 26 shows F is spectra of XPS and deconvoluted peaks of the cycled Li harvested from Li|LP-PP|Li and Li|LP-EMP|Li cells after 200 cycles, according to embodiments of the invention.

FIG. 27 shows SEM images of the cycled Li electrodes from Li|LP-PP|Li and Li|LP-EMP|Li cells, according to embodiments of the invention.

FIG. 28 shows cycle performance of full cells (LiNi_{1/3}Co_{1/3}Mn_{1/3}O₂ (NCM) as cathode and graphite as anode) using the electrolyte saturated PP and EMP, according to embodiments of the invention.

FIG. 29 shows rate performance of full cells (LiNi_{1/3}Co_{1/3}Mn_{1/3}O₂ (NCM) as cathode and graphite as anode) using the electrolyte saturated PP and EMP, according to embodiments of the invention.

FIG. 30 shows measurement of lithium ion transference number of the electrolyte (1M LiClO₄ in propylene carbonate, denoted as LC) in EMP, according to embodiments of the invention.

FIG. 31 shows measurement of lithium ion transference number of the electrolyte (LC) saturated PP, according to embodiments of the invention.

FIG. 32 shows measurement of lithium ion transference number of the electrolyte (LC) in composite separator with inactivated UiO-66, according to embodiments of the invention.

FIG. 33 shows cyclic voltammetry curves of SS|electrolyte|Li cells with LC-PP and LC-EMP under a sweep rate of 1 mV s⁻¹, according to embodiments of the invention.

FIG. 34 shows rate performance of full cells (LiFePO₄ (LFP) as cathode and Li₄Ti₅O₁₂ (LTO) as anode) using the electrolyte saturated PP and EMP, according to embodiments of the invention.

FIG. 35 shows cycle performance of full cells (LiFePO₄ (LFP) as cathode and Li₄Ti₅O₁₂ (LTO) as anode) using the electrolyte saturated PP and EMP, according to embodiments of the invention.

### DETAILED DESCRIPTIONS OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements can be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. can be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

Furthermore, relative terms, such as “lower” or “bottom” and “upper” or “top,” can be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method can be executed in different order (or concurrently) without altering the principles of the invention.

This invention, in one aspect, relates to a composite separator used for an electrochemical device, comprising a membrane comprising at least one polymer and at least one metal organic framework (MOF) material defining a plurality of pore channels, wherein the at least one MOF material is activated at a temperature for a period of time. The at least one MOF material is a class of crystalline porous scaffolds constructed from metal clusters with organic ligands and comprises unsaturated metal centers, open metal sites and/or structural defects that are able to complex with anions in electrolyte. The membrane is formed by electrospinning of a mixture of the at least one MOF material with a polymer solution comprising the at least one polymer dissolved in at least one solvent, such that the membrane has a porous structure with tunable pore sizes and bead-threaded fibrous morphology.

In one embodiment, the organic ligands comprise benzene-1,4-dicarboxylic acid (BDC), benzene-1,3,5-tricarboxylic acid (BTC), biphenyl-4,4′-dicarboxylic acid (BPDC), or their derivatives, and the metal clusters comprise magnesium (Mg), Aluminium (Al), Titanium (Ti), Vanadium (V), Chromium (Cr), Manganese (Mn), Iron (Fe), Cobalt (Co), Nickel (Ni), Copper (Cu), Zinc (Zn), or Zirconium (Zr).

In one embodiment, the at least one MOF material comprises HKUST-1, MIL-100-Al, MIL-100-Cr, MIL-100-Fe, UiO-66, UiO-67, PCN series, MOF-808, MOF-505, MOF-74, or their combinations.

In one embodiment, the BDC ligand is replaceable by 2-amino-benzenedicarboxylic acid (H₂N-H₂BDC), 2-nitro-benzenedicarboxylic acid (O₂N-H₂BDC), 2-bromo-benzenedicarboxylic acid (Br-H₂BDC), or terephthalate-based linkage ligands.

In one embodiment, the at least one polymer comprises silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof, or their combinations.

In one embodiment, the at least one solvent comprises acetone, water, methanol, ethanol, acetic acid, dimethylformamide (DMF), acetone, water, methanol, ethanol, acetic acid, dimethylformamide (DMF), dimethylacetamide (DMAc), N-Methyl-2-pyrrolidone (NMP), tetrahydrofuran (THF), or their combinations.

In one embodiment, an amount of the MOF material in the composite separator is in a range of about 20-95 wt %.

In another aspect, the invention relates to a method of fabricating a composite separator, comprising providing a suspension mixture to an electrospining apparatus having a metal nozzle, wherein the suspension mixture comprises at least one MOF material dispersed in a polymer solution comprising at least one polymer dissolved in at least one solvent; applying a voltage between the metal nozzle and a collector substrate positioned at a distance from the metal nozzle; extruding the suspension mixture from the metal nozzle at a feeding rate so as to generate electrospun fibers and deposit the generated fibers on the collector substrate to form a mat comprising entangled fibrous networks with a non-woven structure; and hot-pressing the mat into a membrane to form a composite separator.

In one embodiment, the method further comprises heating the membrane was at a temperature under vacuum to prevent rehydration of activated MOF during process.

In one embodiment, the voltage is in a range of about 1-50 kV, the feeding rate is about 1 mL h⁻¹, and the fibers have diameters ranging from tens of micrometers to tens of nanometers, and the composite separator has a thickness that is collectively tuned by the feeding rate and operation time.

In one embodiment, the at least one MOF material comprises HKUST-1, MIL-100-Al, MIL-100-Cr, MIL-100-Fe, UiO-66, UiO-67, PCN series, MOF-808, MOF-505, MOF-74, or their combinations.

In one embodiment, the at least one polymer comprises silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof, or their combinations.

In one embodiment, the at least one solvent comprises acetone, water, methanol, ethanol, acetic acid, dimethylformamide (DMF), acetone, water, methanol, ethanol, acetic acid, dimethylformamide (DMF), dimethylacetamide (DMAc), N-Methyl-2-pyrrolidone (NMP), tetrahydrofuran (THF), or their combinations.

In a further aspect, the invention relates to an electrochemical device, comprising a positive electrode, a negative electrode, an electrolyte disposed between the positive and negative electrodes, and a separator disposed in the electrolyte. The electrolyte is an liquid electrolyte comprising a metal salt dissolved in a non-aqueous solvent. The separator is the composite separator as disclosed above.

In one embodiment, the non-aqueous solvent comprises one or more of ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, and cyclic ether compounds including at least one of tetrahydrofuran, 2-methyltetrahydrofuran, 1,3-dioxolane and dioxane.

In one embodiment, anions in the liquid electrolytes are spontaneously adsorbed by the at least one MOF material and immobilized within the pore channels, thereby liberating metal ions and leading to the metal ions transport with a metal ion transference number higher than that of a separator without the at least one MOF material.

In one embodiment, the metal ions transference number is a ratio of a metal ion conductivity to an ionic conductivity, wherein the ionic conductivity is a total value of the metal ion conductivity and anionic conductivity.

In one embodiment, the metal ion transference number of the liquid electrolytes in the composite separator is in a range of about 0.5-1.

In one embodiment, the metal salt comprises one or more of a lithium salt, a sodium salt, a magnesium salt, a zinc salt, and an aluminum salt.

In one embodiment, the lithium salt comprises one or more of lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, and lithium chloride.

In one embodiment, the sodium salt comprises one or more of sodium trifluoromethanesulfonate, NaClO₄, NaPF₆, NaBF₄, NaTFSI (sodium(I) Bis(trifluoromethanesulfonyl)imide), and NaF SI (sodium(I) Bis(fluorosulfonyl)imide).

In one embodiment, the magnesium salt comprises one or more of magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), and Mg(FSI)₂ (magnesium(II) Bis(fluorosulfonyl)imide).

In one embodiment, the zinc salt comprises one or more of zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide).

In one embodiment, the electrochemical device is a lithium battery, a sodium battery, a magnesium battery, or a zinc metal battery.

In one embodiment, for the lithium battery, the positive electrode comprises one or more of LiCoO₂ (LCO), LiNiMnCoO₂(NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide including LiNi_{0.8}Co_{0.15}Al_{0.05}O₂ or NCA, lithium vanadium oxide (LiV₂O₅), and Li₂MSiO₄ with M being composed of a ratio of Co, Fe, and/or Mn; and the negative electrode comprises one or more of lithium metal (Li), graphite, hard or soft carbon, graphene, carbon nanotubes, titanium oxide including at least one Li₄Ti₅O₁₂ and TiO₂, silicon (Si), tin (Sn), germanium (Ge), silicon monoxide (SiO), silicon oxide (SiO₂), tin oxide (SnO₂), and transition metal oxide including at least one of Fe₂O₃, Fe₃O₄, Co₃O₄ and MnₓO_{y}.

In one embodiment, the positive electrode comprises one or more of NaMnO₂, NaFePO₄ and Na₃V₂(PO₄)₃ for the sodium battery, one or more of TiSe₂, MgFePO₄F, MgCo₂O₄ and V₂O₅ for the magnesium battery, or one or more of γ-MnO₂, ZnMn₂O₄, and ZnMnO₂ for the zinc battery.

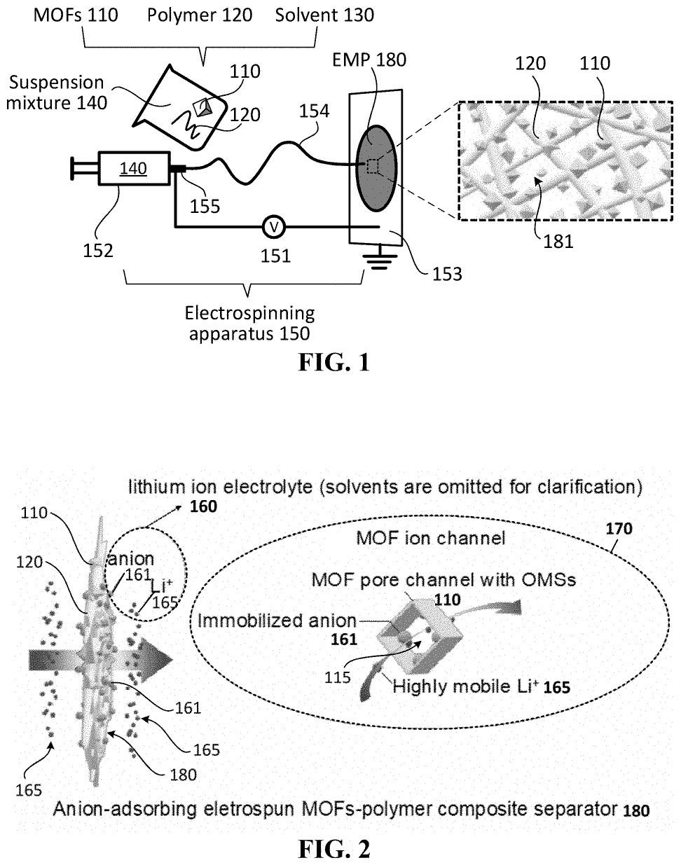

Referring to the FIG. 1, a composite separator comprising MOFs 110 and polymer 120 is fabricated by a simple yet efficient electrospinning technique 150, which can produce non-woven fibrous mats 180 with highly tunable pore size and structure 181. Upon adding liquid electrolytes, the anions in the electrolytes are spontaneously adsorbed by the MOFs particles and immobilized within the pore channels, while liberating the lithium ions and leading to Li⁺ transport with high Li⁺ transference number (t_{Li}⁺).

The MOFs 110 are a class of crystalline porous scaffolds constructed from metal cluster nodes and organic ligands and represent a class of porous coordination solids with versatile structural and functional turnabilities. In certain embodiments, the particles of MOFs are constructed by periodically bridging inorganic metal clusters with organic ligands (linkers), forming pore windows generally below about 2 nanometres, yet mesoporous MOFs can be prepared by isoreticular expansion of organic ligands. Suitable ligands are preferably, but are not limited to, benzene-1,4-dicarboxylic acid (BDC), benzene-1,3,5-tricarboxylic acid (BTC) and their derivatives. Suitable metal clusters include, but are not limited to, magnesium (Mg), Aluminium (Al), Titanium (Ti), Vanadium (V), Chromium (Cr), Manganese (Mn), Iron (Fe), Cobalt (Co), Nickel (Ni), Copper (Cu), Zinc (Zn), Zirconium (Zr), or the like.

Exemplified MOFs used in the invented separator include, but are not limited to, the following symbolic MOFs or with similar structures: UiO-66, MiL-100, PCN series, MOF-808, MOF-505, MOF-74, and HKUST-1.

For example, in one embodiment, UiO-66 has a formula of Zr₆O₄(OH)₄(BDC)₆ and is resulted by connecting hexanuclear zirconium clusters with the formula of Zr₆O₄(OH)₄ and 1,4-benzenedicarboxylate (BDC). In each cluster, 6 Zr generate an octahedron, and each octahedron is 12-fold connected by BDC to adjacent octahedra. The structure contains two types of cages: an octahedral cage that is face sharing with 8 tetrahedral cages and edge sharing with 8 additional octahedral pores, the pore sizes of them are about 9 Å and about 6 Å, respectively. BDC can be replaced by 2-amino-b enzenedicarboxylic acid (H₂N-H₂BDC), 2-nitro-benzenedicarboxylic acid (O₂N-H₂BDC), and 2-bromo-benzenedicarboxylic acid (Br-H₂BDC) and other terephthalate-based linkage ligands.

In certain embodiments, MiL-100 serious is built from trimers of Cr (Al, Fe) octahedra sharing a common vertex μ₃-O. The trimers are linked by the benzene-1,3,5-tricarboxylate (BTC) moieties, leading to the formation of hybrid supertetrahedra which further assemble into a zeolitic architecture of the MTN type. This delimits two types of mesoporous cages of free apertures of about 25 and 29 Å. MIL-100-Al has a formula of Al₃O(OH)(BTC)₂, MIL-100-Cr has a formula of Cr₃O(OH)(BTC)₂, and MIL-100-Fe has a formula of Fe₃O(OH)(BTC)₂.

In certain embodiments, PCN-224-M is typically constructed by connecting the octahedral Zr₆(μ_{3-O})₄(μ₃-OH)₄(OH)₆(OH₂)₆(COO⁻)₆ secondary building units (SBUs) with six TCPP ligands, forming two open channels with node-to-node diameters of about 23.7 and 15.1 Å, respectively, and a pore diameter of about 19 Å.

In certain embodiments, the structure of MOF-808 is typically constructed by connecting Zr secondary building unit (SBU), Zr₆O₄(OH)₄(−CO₂)₆(HCOO)₆, with six BTC units to form a 3-D porous framework and each of the linkers is coordinated to three SBUs. The 6,3-connected three-dimensional framework has an overall span topology. Tetrahedral cages with internal pore diameters of about 4.8 Å are formed, with the inorganic SBUs at the vertices and the BTC linkers at the faces of the tetrahedron. A large adamantane cage is formed with an internal pore diameter of about 18.4 Å.

In certain embodiments, the structure of MOF-505 is typically constructed from connecting Cu₂(COO)₄ with distorted square planar 3,3′,5,5′-biphenyltetracarboxylate (BPTC) organic linkers. The Cu₂(CO₂)₄ unit is a square secondary building unit (SBU) and the bptc⁴⁻ unit is a rectangular SBU. The carboxylate functionalities of the bptc⁴⁻ ligand are nearly coplanar with the biphenyl rings. The arrangement yields an overall 3-periodic network which has two kinds of pores. The first of these pores is defined by six inorganic SBUs with a pore diameter of about 8.30 Å, while the second, and larger, pore is defined by six organic SBUs and has a pore diameter of about 10.10 Å.

HKUST-1 has a formula of Cu₃(BTC)₂. In certain embodiments, the structure of HKUST-1 is composed of BTC ligands coordinating with copper ions in a cubic lattice (Fm-3m). It contains an intersecting 3-D system of large square shaped pores of about 9×9 Å. In the framework of HKUST-1, Cu (II) ions form dimmers, where each copper atom is coordinated by four oxygen from BTC linkers and water molecules.

In certain embodiments, the structure of the MOF-74 is built around a 1-D honeycomb motif with pores of about 11-12 Å diameter and helical chains of edge-condensed metal—oxygen coordination octahedrals located at the intersections of the honeycomb, in which the metal is square—pyramidally coordinated.

The symbolic MOFs are exemplifying embodiments of MOFs 110, yet other porous coordination solids containing metal clusters bridged by organic linkers can also be enclosed as MOFs 110 described herein. The MOFs 110 herein can also contain structural defects, such as missing organic linkers, missing anionic ligands, or the like.

In certain embodiments, suitable polymer 120 used in electrospinning include, but are not limited to, silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof or their combinations.

In certain embodiments, solvent 130 is used to dissolve polymer 120. MOFs particles 110 can be homogeneously dispersed in the polymer solution via rigorous mixing, forming suspension mixture. Suitable solvent 130 to be used in electrospinning include, but is not limited to, acetone, water, methanol, ethanol, acetic acid, dimethylformamide (DMF), dimethylacetamide (DMAc), N-Methyl-2-pyrrolidone (NMP), and/or tetrahydrofuran (THF).

In certain embodiments, a suspension mixture 140 is formed by dissolving the polymer 120 in the solvent 130 to obtain a polymer solution and dispersing the MOFs 110 in the polymer solution. The suspension mixture 140 is operably continuously extruded to produce non-woven free-standing separator via electrospinning techniques. As referring to FIG. 1, a commercially available electrospining apparatus 150 is shown, which comprises a high voltage power supply 151, a springe 152 with a metal spinning nozzle 155, and a grounded collector 153. During the operation of electrospinning, the electrostatic force overcomes the surface tension of the drop of the suspension at the dip of the spinning nozzle 155 once the voltage reaches a critical value. The extruded nanofibers 154 continuously deposit on the collector 153, forming entangled fibrous networks with a non-woven structure 180.

In certain embodiments, the controlled relevant parameters of the electrospinning process include, but are not limited to, voltage between the needle 155 and the collector 153, the distance between the needle 155 and the collector 153, a feeding rate, the concentration of the suspension mixture (solution) 140. In an example, typical values of the voltage applied are in the range of about 1 to 5 kV, a desirable feeding rate of the suspension mixture 140 is about 1 mL h⁻¹. The diameters of fibers 154 produced range from several micrometers down to tens of nanometers. The thickness of the separator is collectively and operably tuned by the spinning rate and operation time.

The advantage of the electrospinning process in producing non-woven separators over other methods is that the electrospinning can prepare microporous separators with tunable pore sizes, high permeability, high surface areas and high porosity that are suitable for applications of lithium batteries. Yet other methods of producing non-woven separators can also be applied to practice the invention.

Referring to FIG. 2, the feature and functionalities of a MOF particle 110 in the composite separator 180 and electrolyte 160 are shown. The open metal sites (OMSs) in the MOF skeleton are defined as the unsaturated coordination sites from metal centers, which can be derived from eliminations of coordinated solvents or ligands on metal sites by thermal treatments (or thermal activation). The unsaturated metal sites can bound anionic species 161 in electrolyte 160, affording highly mobile lithium ions 165 through MOF pore channels 115.

Generally, MOFs are synthesized in the presence of a solvent (e.g., water) and the ligands, both of which coordinate with the MOF's metal centers. Removal of the solvent molecules (e.g., at an elevated temperature under vacuum) breaks the solvent coordination from the MOFs, resulting in MOF scaffolds with unsaturated metal centers. The conditions for solvent molecule removal may include a temperature ranging from about 200° C. to about 220° C. at a pressure of about 30 mTorr. This temperature range can be suitable for removing any solvent, although it is to be understood that high boiling point solvent may require longer evacuation times than low boiling point solvents. In one example, the powder form MOF material is degassed or activated under vacuum at a high/elevated temperature (e.g., from about 200° C. to about 220° C.) to remove absorbed water molecules. Other solvent molecule removal methods may also be used to practice the invention.

The solvent(s) of the liquid electrolyte 160 can be ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds such as gamma butyrolactone, gamma valerolactone, 1,2-dimethoxyethane, and diethyl ether, cyclic ether compounds such as tetrahydrofuran, 2-methyltetrahydrofuran, 1,3-dioxolane, and dioxane, or mixtures of two or more of these solvents.

Examples of suitable lithium salts of the liquid electrolytes 160 include, but are not limited to, lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, or combinations thereof.

The interaction 170 between MOFs 110 and anions 161 of the electrolyte 160 includes, but is not limited to: (1) the coordination between OMSs on MOF 110 with anions 161, (2) the interaction between the anions 161 and the ligands in MOFs 110 by post-synthesis, (3) size exclusion between the pores 115 of MOFs 110 with limited size and anions 161.

Compared with a commercial polyolefin-based separator, the advantages of presented electrospun composite separators according to the invention include, but are not limited to, (1) improved lithium ion transference number; (2) mitigated concentration polarization; (3) accelerated electrode reaction kinetics; (4) reduced interfacial resistance between electrodes and electrolyte; (5) suppressed dendritic lithium formation; (6) enhanced power density; (7) extended cycle lifespan; and (8) improved thermal stability.

For lithium-based batteries, the positive electrode in certain embodiments can be formed of LiCoO₂ (LCO) and the negative electrode can be formed of lithium metal (Li). Other examples of suitable positive electrodes include, but are not limited to, LiNiMnCoO₂ (NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide (e.g., LiNi_{0.8}Co_{0.15}Al_{0.05}O₂ or NCA), lithium vanadium oxide (LiV₂O₅), Li₂MSiO₄ (M is composed of any ratio of Co, Fe, and/or Mn), or any other suitable material that can sufficiently undergo lithium insertion and deinsertion. Other examples of suitable negative electrodes include, but are not limited to, graphite, hard or soft carbon, graphene, carbon nanotubes, titanium oxide (Li₄Ti₅O₁₂, TiO₂), silicon (Si), tin (Sn), Germanium (Ge), silicon monoxide (SiO), silicon oxide (SiO₂), tin oxide (SnO₂), transition metal oxide (Fe₂O₃, Fe₃O₄, Co₃O₄, MnₓO_{y}, etc), or any other suitable material that can undergo intercalation, conversion or alloying reactions with lithium.

These and other aspects of the present invention are further described in the following section. Without intending to limit the scope of the invention, further exemplary implementations of the present invention according to the embodiments of the present invention are given below. Note that titles or subtitles can be used in the examples for the convenience of a reader, which in no way should limit the scope of the invention. Moreover, certain theories are proposed and disclosed herein; however, in no way should they, whether they are right or wrong, limit the scope of the invention so long as the invention is practiced according to the invention without regard for any particular theory or scheme of action.

### EXAMPLE 1

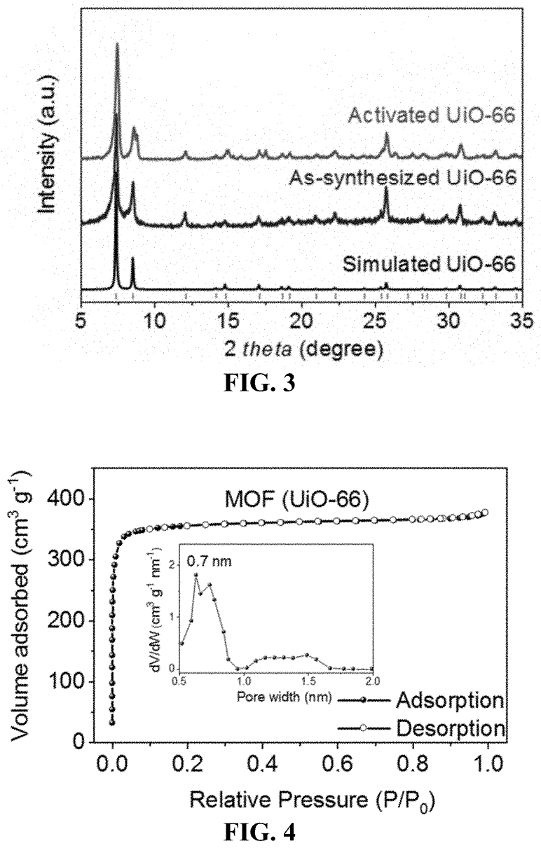

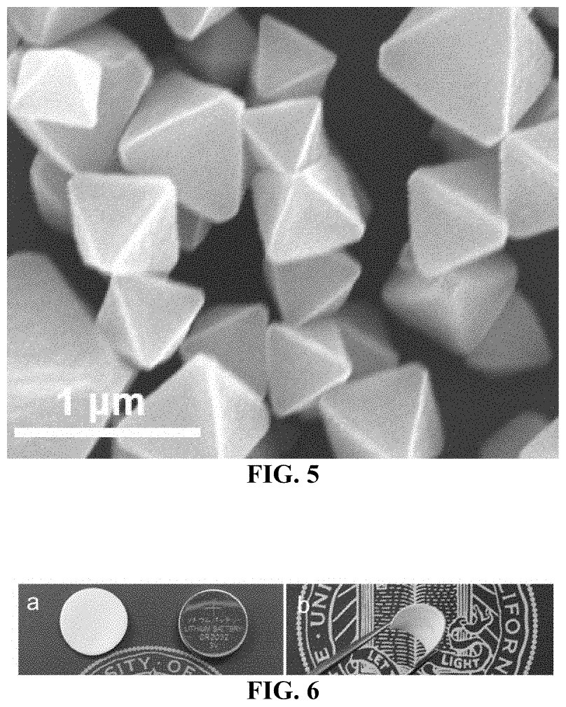

In this exemplary example, UiO-66 was synthesized using a solvothermal method adopted with modification from the literature. About 1.82 g of BDC and about 2.33 g of ZrCl₄ were dissolved in about 150 mL of N,N-Dimethylformamide (DMF), then about 1 mL 37% HCl and about 24.4 g benzoic acid were added to control the size of particles. The solution was magnetically stirred for about 30 minutes and then transferred into a sealed vessel. The vessel was heated at about 120° C. for about 72 h and then cooled to room temperature, giving about 2.47 g white powder (yield: about 62%). The collected sample was washed by DMF three times, recovered through methanol and dried at about 80° C. for about 1 day. The dried UiO-66 was further heated at about 300° C. under dynamic vacuum for about 24 h to thermally activate the MOF. The crystalline structure of the MOFs particles before and after the heat treatment was examined by x—ray diffraction (XRD). As shown in FIG. 3, the major diffraction patterns of the MOFs particles before and after activation are consistent with the simulated UiO-66 patterns, showing the structure integrity and crystallinity of the MOFs before and after the thermal treatment. The MOFs particles exhibit a high Brunauer-Emmett-Teller (BET) surface area of about 1140 m² g⁻¹ and an average pore size of about 0.7 nm, as shown in FIG. 4. The MOFs particles show a regular octahedron-shape with an average size of about 300 nm, as shown in FIG. 5.

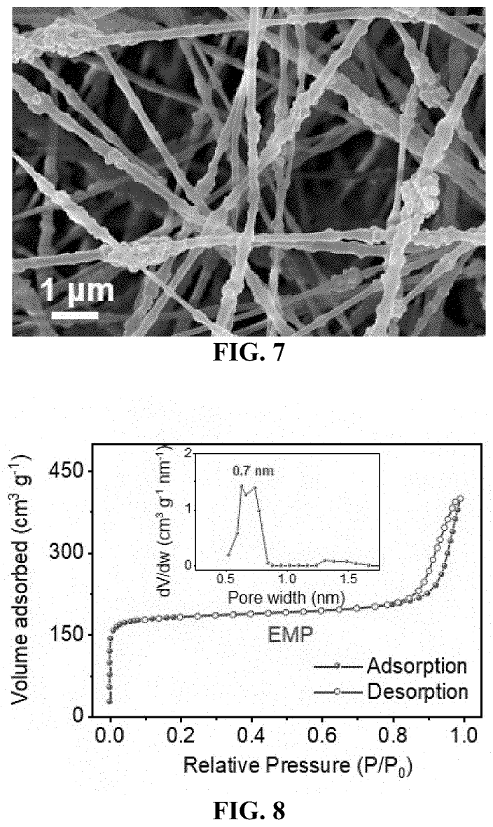

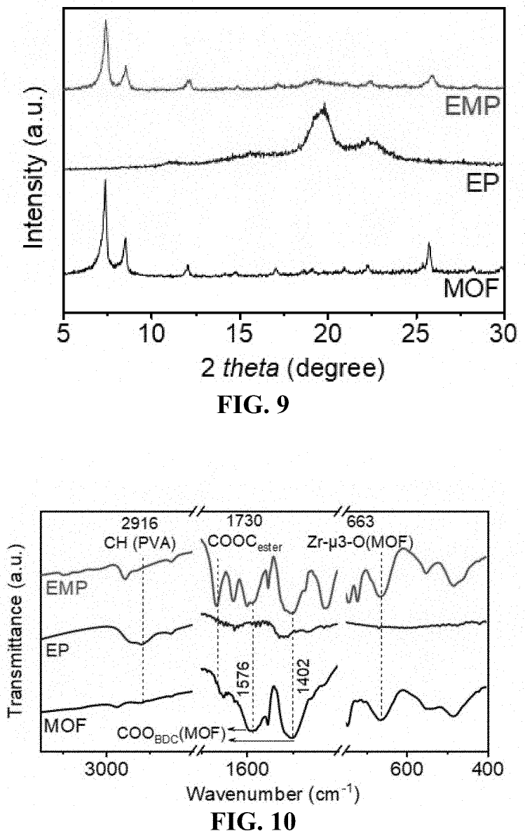

About 1 g PVA (Mw=88000 g mol⁻¹, 99% hydrolyzed) was swelled in about 20 mL water for about 6 h at room temperature and stirred at about 90° C. for about 24 h to achieve complete solvation of PVA. Afterwards about 1.5 g activated UiO-66 was homogeneously dispersed into the PVA solution. About 1 mL h⁻¹ solution feed rate, about 40 kV applied direct-current (DC) voltage and about 10 cm distance between the needle and collector were set as the key electrospinning parameters. The resulting electrospun membrane was peeled off from the collector and hot pressed at about 150° C. and 100 MPa to reach a uniform membrane thickness of about 60 um (a real density about 2.4 mg cm⁻²). Before device fabrication, the membrane was heating at 200° C. under vacuum to prevent rehydration of activated MOF during process. The free-standing EMP, as show in FIG. 6, exhibits bead-threaded fibrous morphology, as shown in FIG. 7, and high BET surface area of 599 m² g⁻¹, as shown in FIG. 8. FIG. 9 shows the XRD patterns of the EP and EMP. Two board peaks at about 20° (101) and about 22.5° (200) are observed attributed by the PVA moieties, and two sharp peaks at about 7.4° (111) and about 8.5° (200) are attributed by the MOFs particles.

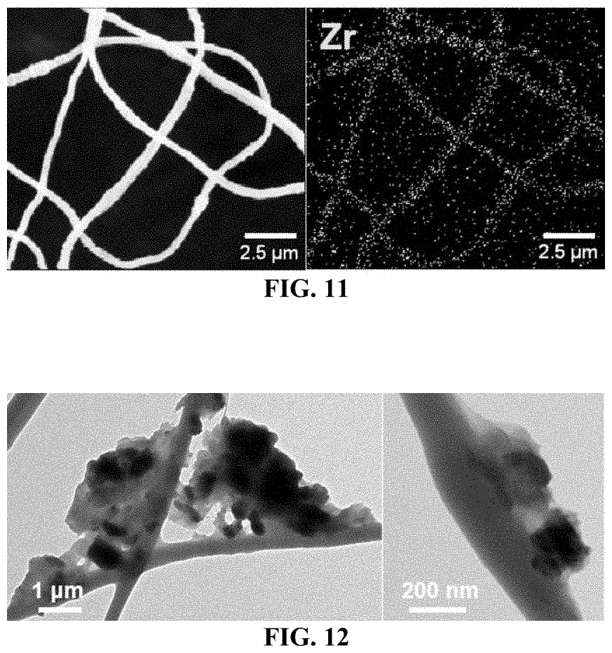

The Fourier transform infrared spectroscopy (FTIR) spectra shown in FIG. 10 reveal the esterification between the PVA and MOFs particles. The peak at about 663 cm⁻¹ and about 1576/1402 cm⁻¹ are ascribed to the metal clusters (Zr—μ₃—O) and the ligands (COO from BDC) in the MOFs particles, respectively. The peak at about2916 cm⁻¹ in EP is associated with the PVA (CH stretching). The emergence of the ester (COOC) bonds at about 1730 cm⁻¹ in EMP suggests the esterification between the PVA and MOFs particles, which promotes the anchoring of the MOFs particles on the fibrous networks, as well as crosslinking of the networks. Meanwhile, the elimination of hydroxyls can also benefit the battery performances. The energy dispersive x-ray spectroscopy shown in FIG. 11 and transmission electron microscopy (TEM) shown in FIG. 12 verify the homogenous distribution of UiO-66 throughout PVA matrix. The weight ratio of the MOFs particles in EMP is about 60 wt % determined by TGA as shown in FIG. 12.

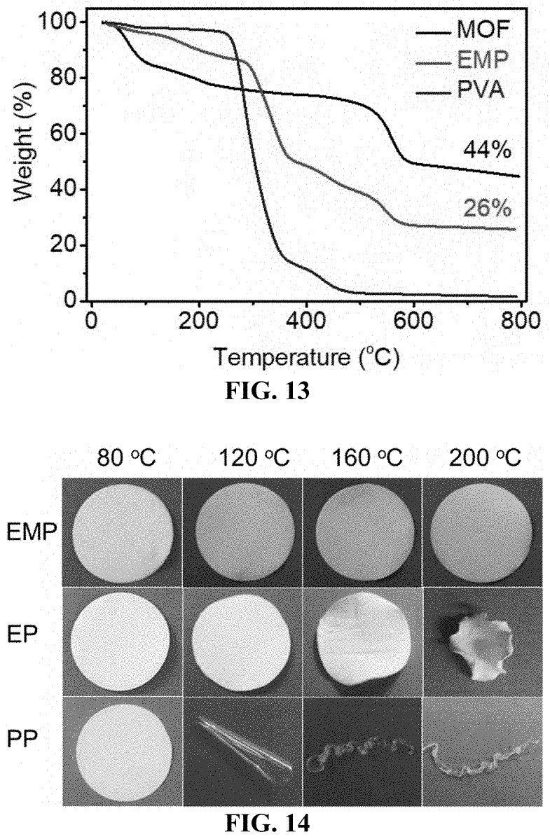

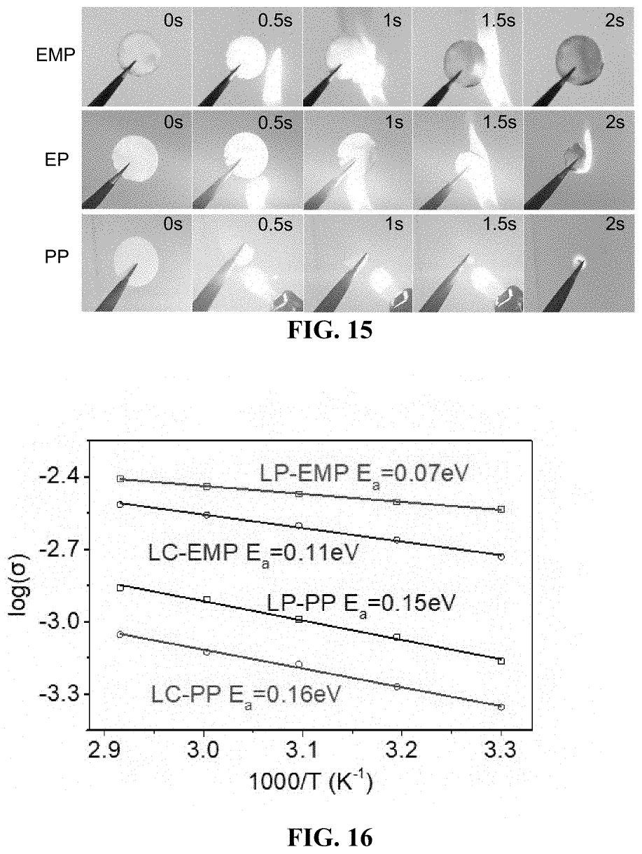

The thermal stability and flammability of the EMP were compared with those of EP and commercial polypropylene (PP) separators. FIG. 13 shows the optical photographs of these separators placed at about 80° C., about 120° C., about 160° C. and about 200° C. for about 1 hour. The EP and PP exhibit drastic dimensional shrinkage starting from about 120° C. and about 160° C., respectively. In comparison, the EMP well maintains its original dimensional and integrity up to about 200° C., demonstrating an enhanced thermal stability. Moreover, as shown in FIG. 14 of the flammability tests, the PP is immediately melted and burned out upon contacting with a flame; similarly, the EP is also easily ignited and combusted. In contrast, the EMP exhibits only minor decomposition, proving that the MOFs can serve as a fire retardant for separators.

The Li⁺ conductivity of the composite separators was measured by electrochemical impedance spectroscopy (EIS), where about 1M LiPF₆ in ethylene carbonate/diethyl carbonate (denoted as LP) or about 1M LiClO₄ in propylene carbonate (denoted as LC) were used as electrolytes. PP-based membranes (Celgard) were selected as reference separators. In one embodiment, the electrolyte-soaked separator disk (flow-free on surface) with certain thickness (t) and diameter (e.g., about 14 cm) was sandwiched between two stainless steel plates. The impedance spectra were taken in a frequency range from about 0.1 Hz to about 10⁶ Hz with alternating-current (AC) voltage amplitude of about 10 mV. The resistance of electrolyte (R) was determined by the intercept of Nyquist plot with real axis. The ionic conductivity (σ) was thereby calculated by equation;

σ=t/(R×S),

where S is a surface area). By measuring and fitting the ionic conductivity as a function of temperature (T), the activation energy (Eₐ) can be derived from Arrhenius equation:

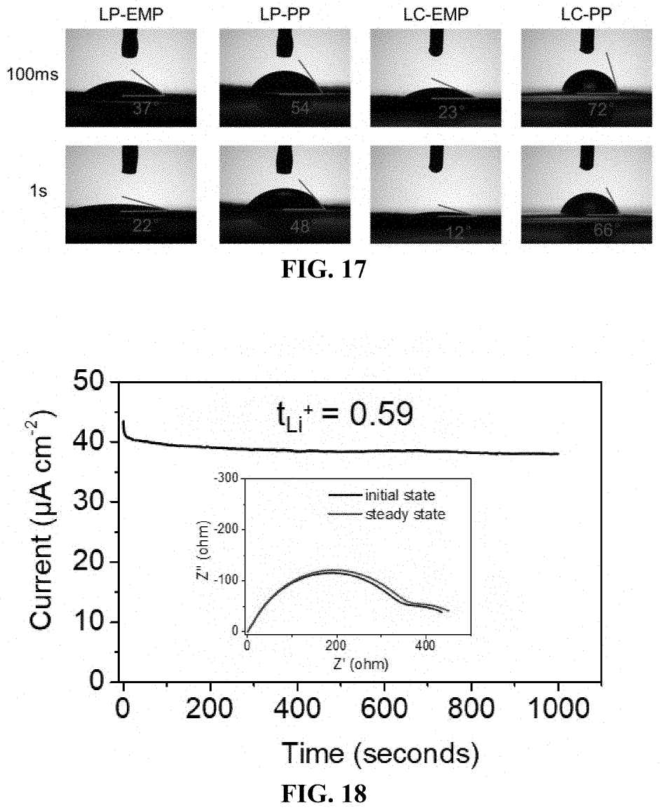

σ=σ₀×exp(−Eₐ/kT),

where k and σ₀ are constants. FIG. 16 shows the temperature dependent ionic conductivity (the dots) and corresponding linear fitting results (the straight lines) based on the Arrhenius equation. At ambient temperature (about 30° C.), EMP with LP (denoted as LP-EMP) and EMP with LC (denoted as LC-EMP) exhibit an ionic conductivity of about 2.9 mS cm⁻¹ and about 1.9 mS cm⁻¹, respectively. These values are substantially higher than those of the PP separators with LP (LP-PP, about 0.7 mS cm⁻¹) and with LC (LC-PP, about 0.5 mS cm⁻¹). Such improvement can be interpreted from two aspects. First, the EMP possesses a higher surface area, enabling more electrolyte uptake (about 230% for EMP vs. about 50% for PP). Second, the PVA matrix improves the wettability between the EMP and the electrolytes, which is evidenced by their lower contact angles with the electrolytes in comparison with those PP, as shown in FIG. 17. Consistently, the EMP-electrolyte systems show lower activation energy (e.g., about 0.15 eV and about 0.07 eV for the LP-PP and LP-EMP, respectively), suggesting that the incorporation of MOFs particles facilitates the ion transport process.

The lithium transference number (t_{Li}⁺) was obtained by AC impedance and DC potentiostatic polarization measurements performed on Li|electrolyte|Li cells. Initial impedance was carried out on fresh cells, the corresponding initial interfacial resistance (Rᵢₙₜ⁰) was estimated by the diameter of semicircle at high-to-medium frequency. Afterwards initial current (I₀) and steady-state current (Iₛₛ) were recorded during potentiostatic polarization with voltage bias of about 20 mV. The lithium transference number t_{Li}⁺ was calculated by the formula:

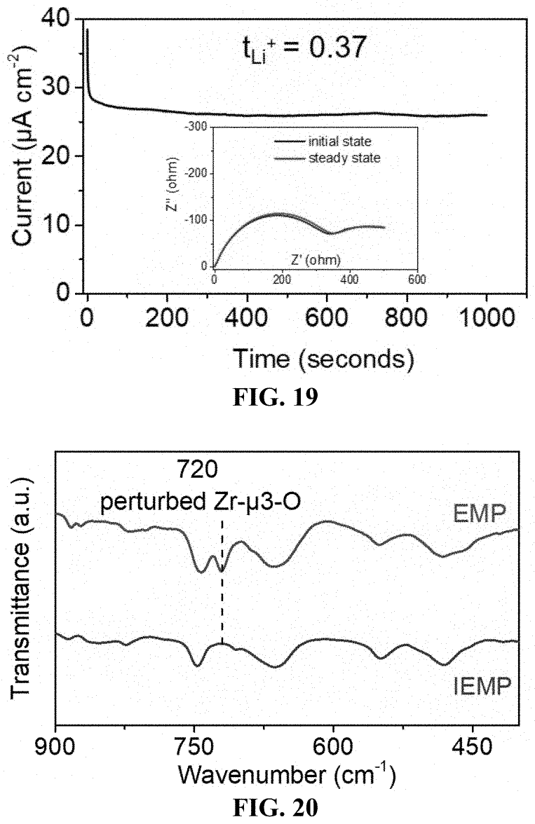

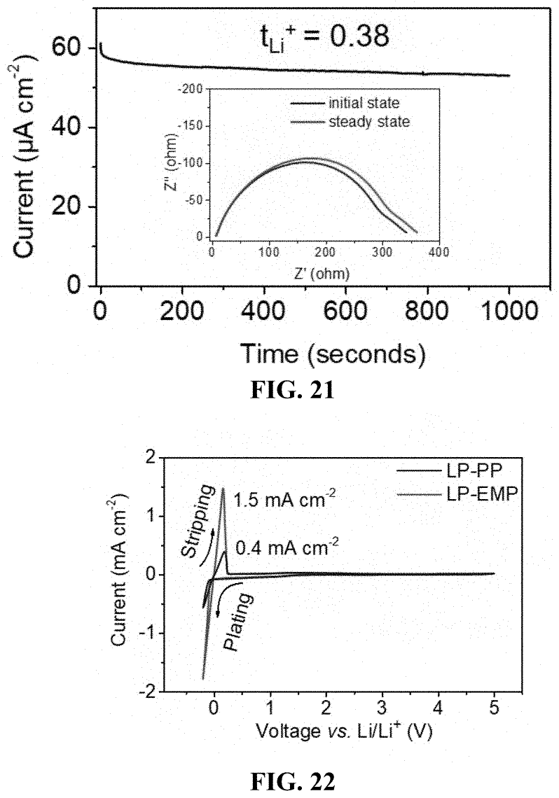

t_{Li}⁺=Iₛₛ(V-I₀Rᵢₙₜ⁰)/I₀(V-IₛₛRᵢₙₜ^{ss})),

where Rᵢₙₜ^{ss} represents the interfacial resistance collected after DC polarization. FIGS. 18 and 19 indicate that the lithium transference number t_{Li}⁺ for LP-PP is about 0.37, which is improved significantly to about 0.59 for LP-EMP. Combining the effect of improving both the ionic conductivity σ and the lithium transference number t_{Li}⁺, the conductivities of lithium ions are improved dramatically. The conductivity of lithium ions increases from about 0.3 mS cm⁻¹ to about 1.7 mS cm⁻¹ when replacing PP with EMP in LP, respectively. In addition, an inactivated electrospun MOF-PVA composite separator (denoted as IEMP) was also prepared using un-treated MOFs particles (without OMSs). FIG. 20 compares the FTIR spectra of an EMP and IEMP. For IEMP, the absence of the peak at about 720 cm⁻¹ indicates the Zr metal clusters were still hydroxylated and the OMSs were not generated yet. As expected, the lithium transference number t_{Li}⁺ of LP (0.38) in the presence of IEMP is in line with the values obtained with PP, confirming that the role of OMSs on improving the lithium transference number t_{Li}⁺, as shown in FIG. 21.

The electrochemical stability and Li⁺ stripping/plating kinetics of electrolytes in EMP were evaluated by cyclic voltammetry (CV) tests with a two-electrode system, where stainless-steel disks (SS) were used as the working electrodes and Li metal foils were used as the counter/reference electrodes (denoted as SS|electrolyte|Li cell). FIG. 22 show the CV curves of SS|ILP-EMP|Li cell and SS|LP-PP|Li cell. The two predominant redox peaks near 0 V (vs. Li/Li⁺) are attributed to the Li⁺plating and stripping processes on the working electrode. The cell with EMP exhibits a higher peak current density in comparison with PP. For example, the stripping peak current for the SS|LP-EMP|Li cell is about 275% higher than that of SS|LP-PP|Li cell (about 1.5 mA cm⁻² vs. about 0.4 mA cm⁻²). This result is consistent with the enhanced Li⁺ conductivity from EIS and the lithium transference number t_{Li}⁺ measurements.

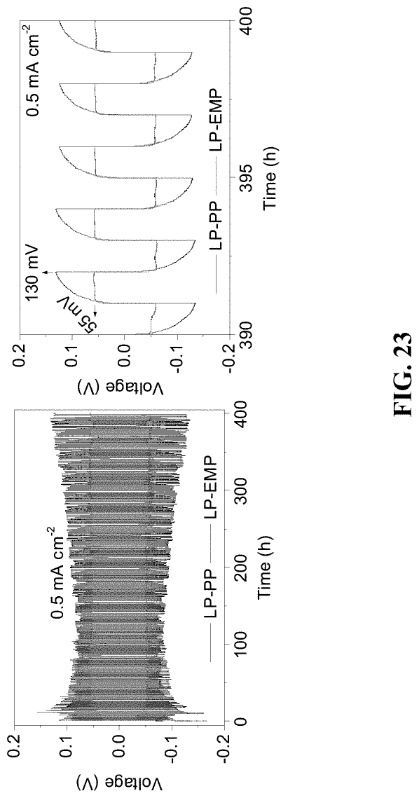

The long-term galvanostatic tests of Li|electrolyte|Li symmetric cells were also performed at about 0.5 mA cm⁻² with a time interval of about 2 h for each cycle. As shown in FIG. 23, the overpotential of Li|LP-PP|Li cell gradually increases up to about 130 mV over a period of about 400 hours of operation. In contrast, the Li|LP-EMP|Li cell shows a stabilized voltage of about 55 mV by the end of test. FIG. 23 also shows the enlarge profiles of the last 5 cycles, where Li|LP-EMP|Li cell displays a flat voltage plateau, while pronounced voltage variation (from about 30 to 130 mV) is observed for the Li|LP-PP|Li cell. Such voltage fluctuation during Li⁺ stripping and plating is a typical sign of the formation of Li dendrites or mossy surface, demonstrating that the use of EMP successfully stabilizes the electrolyte-electrode interface and suppresses the formation of dendritic lithium structures.

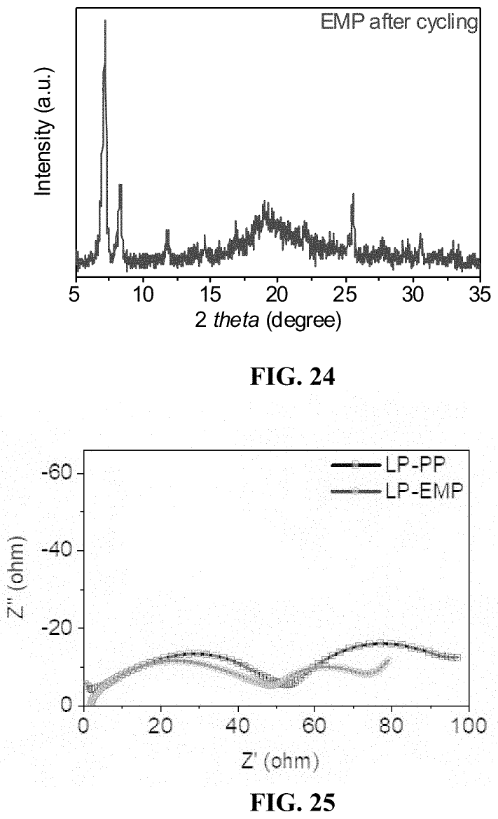

The EMP was harvested from the cycled Li|LP-EMP|Li cell and examined by XRD. The diffraction peaks of cycled EMP are similar to the diffraction pattern of pristine EMP, indicating that the EMP is electrochemically stable against Li, as shown in FIG. 24. EIS was further performed on cycled Li|LP-EMP|Li and Li|LP-PP|Li (after about 200 cycles) cells to quantify their resistances. FIG. 25 compares the Nyquist plots of cycled cells. The diameters of two semicircles at high frequency and high-to-medium frequency represent the resistances of the solid-electrolyte interface and charge transfer, respectively. A reduction in charge-transfer resistance for the Li|LP-EMP|Li cell (about 46 Ω vs. about 62 Ω) implies a faster electrode-reaction kinetics.

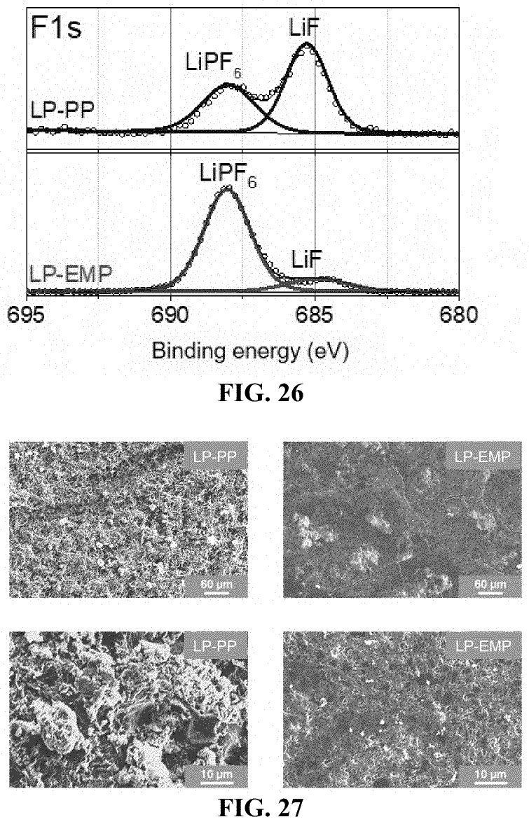

To study whether the immobilization of anions contributes to a more affinitive interface, X-ray photoelectron spectroscopy (XPS) was carried out on cycled Li|LP-EMP|Li and Li|LP-PP|Li cells. Two deconvoluted peaks from the F is spectra are attributed to ionic PF₆⁻ (LiPF₆, about 688 eV) and LiF (about 685 eV), respectively, as shown in FIG. 26. The higher ratio of LiPF₆ in the Li|LP-EMP|Li cell suggests that less anions were decomposed with the presence of MOFs particles. Consistently, the SEM images of Li electrode from Li|LP-PP|Li cell illustrate a rough morphology shown in FIG. 27, while those from the Li|LP-EMP|Li cell demonstrate a relatively compact and smooth surface without obvious formation of dendritic structures, as shown in FIG. 27. Overall, these studies reveal that the EMP not only assists in building a less polarized and stable interface, but also mitigates the decomposition of electrolytes.

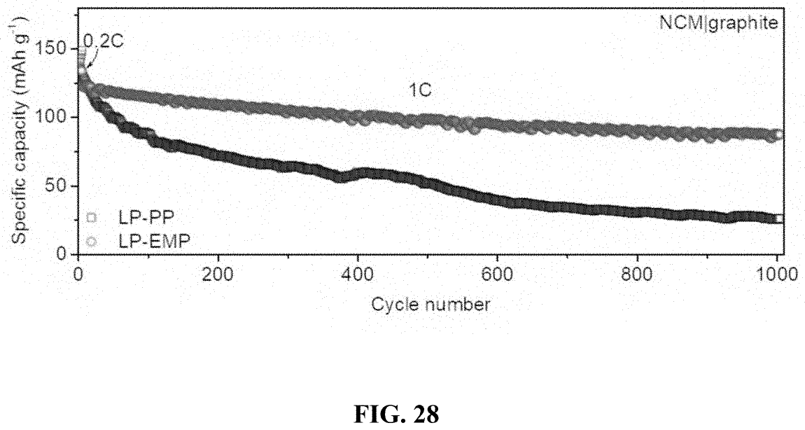

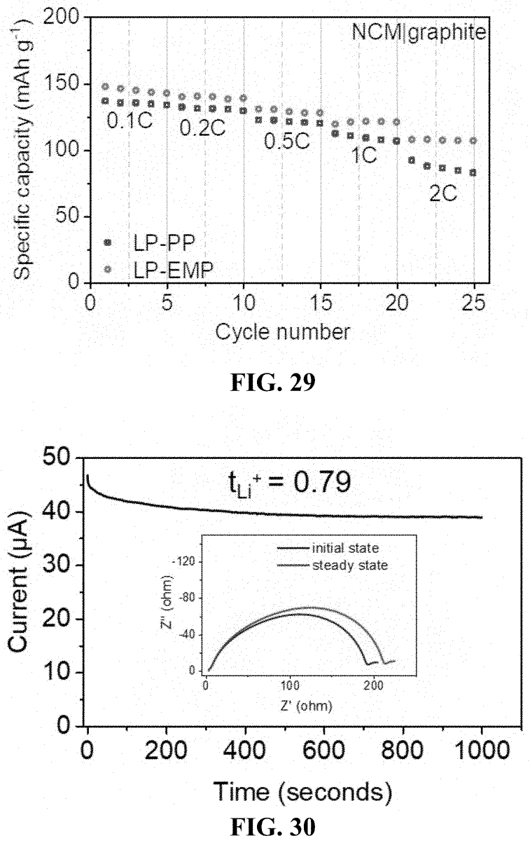

The electrodes for the prototype full cells were prepared by conventional slurry-coating method. Solids containing activate materials (NCM and graphite), acetylene black, and polyvinylidene fluoride (PVdF) were uniformly mixed in a mass ratio of about 90:5:5. The blends were afterwards dispersed in N-methyl-2-pyrrolidone (NMP) forming homogeneous slurry for doctor blade coating. The resulting well-dried NCM electrode are controlled with areal loading of about 20 mg cm⁻² and graphite with about 10 mg cm⁻². Each cell was filled up with a fixed electrolyte volume of about 30 ul. The rate tests were carried out at various current densities with each rate for about 5 cycles, as shown in FIG. 29. Relative to the capacity at about 0.1C rate, the NCM|graphite cell with EMP retains about 74% of its initial capacity, comparing with about 63% for the NCM|graphite cell using PP. The long-term cycling was also carried out at 1C after 5 initial cycles at about 0.2C. As shown in FIG. 28, the NCM|graphite cell with PP shows drastic capacity decay and retains only about 25% of its initial capacity, whereas the NCM|graphite cell with EMP maintains about 73% of the initial capacity after about 1000 cycles at about 1C.

### EXAMPLE 2

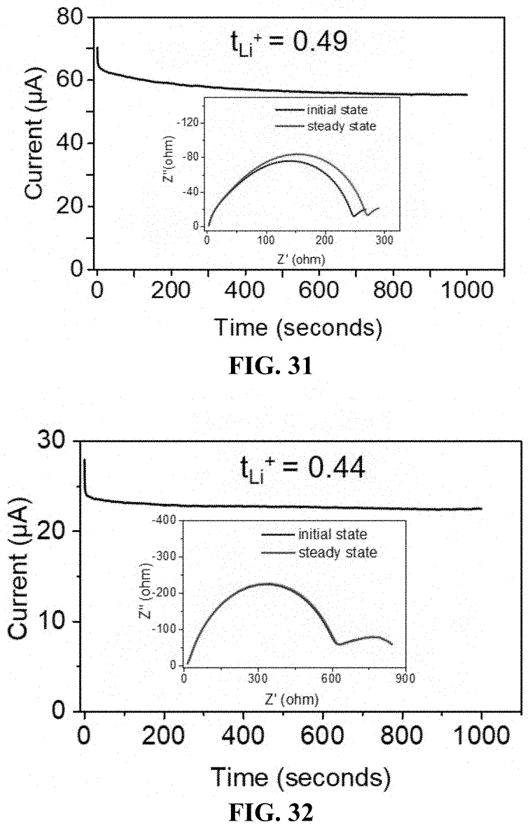

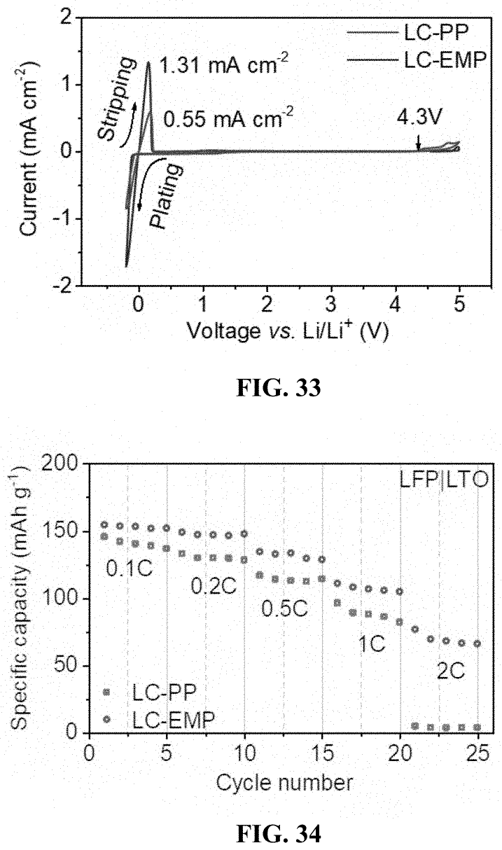

The superiority of EMP is testified in another commonly used electrolyte, 1M LiClO₄ in propylene carbonate (LC). As shown in FIGS. 30 and 31, the lithium transference number t_{Li}⁺ improves from about 0.49 for electrolyte saturated PP to about 0.79 for electrolyte saturated EMP. The composite separator with IEMP shows the lithium transference number t_{Li}⁺ of about 0.44, which is close to the value obtained from PP, as shown in FIG. 32. Meanwhile, the LC-EMP exhibits a higher ionic conductivity of about 1.9 mS cm⁻¹, compared with about 0.5 mS cm⁻¹ form LC-PP, as shown in FIG. 16. The above results are consistent with the enhanced Li⁺ stripping and plating peaks obserbed in SS|LC-EMP|Li compared that with SS|LC-PP|Li, indicating improved electrode reaction kinetics, as shown in FIG. 33.

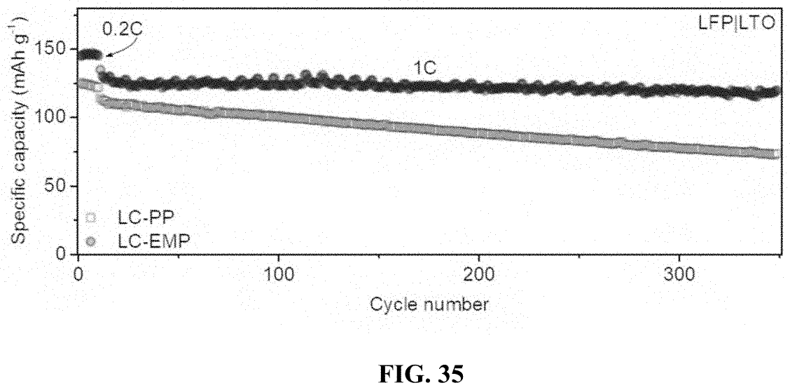

The electrodes for the prototype full cells were prepared by conventional slurry-coating method. Solids containing activate materials (LFP and LTO), acetylene black, and polyvinylidene fluoride (PVdF) were uniformly mixed in a mass ratio of about 7:2:1. The blends were afterwards dispersed in N-methyl-2-pyrrolidone (NMP) forming homogeneous slurry for doctor blade coating. The resulting well-dried LFP electrode are controlled with areal loading of about 5 mg cm⁻² and LTO with about 5 mg cm⁻². The loading was determined by cycling LFP|Li and LTO|Li cells at about 0.05C (1C=170 mA g⁻¹ for LFP and 1C=175 mA g⁻¹ for LTO). Each cell was filled up with a fixed electrolyte volume of about 30 ul. The rate tests were carried out at various current densities with each rate for about 5 cycles. At 2C rate (1C=170 mA g⁻¹), the LFP|LTO cell with EMP still delivers about 44% of its original capacity at about 0.1C, whereas the LFP|LTO cell using PP barely works under such a high rate. The improvement in rate capability of the cells with EMP can be attributed to the high t_{Li}⁺ and mitigated concentration polarizations, as shown in FIG. 34. The long-term cycle stability was evaluated by cycling full cells at 1C except for initial few cycles at about 0.2C (1C=160 mA g⁻¹). The long-term cycling, the LFP|LTO cell with EMP maintains about 89% of the capacity after about 350 cycles, in comparison with about 65% capacity retention for the cell with PP, as shown in FIG. 35.

Briefly, the above disclosed exemplary examples clearly indicate the invention, among other things, achieves at least the following improvements to the lithium batteries: improved lithium transference number; improved overall lithium ion conductivity; reduced interfacial resistance between electrolyte and electrode (cathode or anode); enhanced electrode reaction kinetics; improved electrochemical window of the lithium ion electrolyte; improved power output; improved cycled life; improved thermal stability.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

What is claimed is:

1. A composite separator used for an electrochemical device, comprising:
a membrane comprising at least one polymer and at least one metal organic framework (MOF) material defining a plurality of pore channels,
wherein the at least one MOF material is a class of crystalline porous scaffolds constructed from metal clusters with organic ligands and is activated at a temperature for a period of time such that the at least one MOF material comprises unsaturated metal centers, open metal sites and/or structural defects that are able to complex with anions in electrolyte; and
wherein the membrane is formed by electrospinning of a mixture of the at least one MOF material with a polymer solution comprising the at least one polymer dissolved in at least one solvent, such that the membrane has a porous structure with tunable pore sizes and bead-threaded fibrous morphology.

2. The composite separator of claim 1, wherein the organic ligands comprise benzene-1,4-dicarboxylic acid (BDC), benzene-1,3,5-tricarboxylic acid (BTC), biphenyl-4,4′-dicarboxylic acid (BPDC), or their derivatives, and the metal clusters comprise magnesium (Mg), Aluminium (Al), Titanium (Ti), Vanadium (V), Chromium (Cr), Manganese (Mn), Iron (Fe), Cobalt (Co), Nickel (Ni), Copper (Cu), Zinc (Zn), or Zirconium (Zr).

3. The composite separator of claim 2, wherein the at least one MOF material comprises HKUST-1, MIL-100-Al, MIL-100-Cr, MIL-100-Fe, UiO-66, UiO-67, PCN series, MOF-808, MOF-505, MOF-74, or their combinations.

4. The composite separator of claim 1, wherein the at least one polymer comprises silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof, or their combinations.

5. The composite separator of claim 1, wherein the at least one solvent comprises acetone, water, methanol, ethanol, acetic acid, dimethylformamide (DMF), acetone, water, methanol, ethanol, acetic acid, dimethylformamide (DMF), dimethylacetamide (DMAc), N-Methyl-2-pyrrolidone (NMP), tetrahydrofuran (THF), or their combinations.

6. The composite separator of claim 1, wherein an amount of the MOF material in the composite separator is in a range of about 20-95 wt %.

7. A method of fabricating the composite separator of claim 1, comprising:
providing a suspension mixture to an electrospining apparatus having a metal nozzle, wherein the suspension mixture comprises at least one MOF material dispersed in a polymer solution comprising at least one polymer dissolved in at least one solvent;
applying a voltage between the metal nozzle and a collector substrate positioned at a distance from the metal nozzle;
extruding the suspension mixture from the metal nozzle at a feeding rate so as to generate electrospun fibers and deposit the generated fibers on the collector substrate to form a mat comprising entangled fibrous networks with a non-woven structure; and
hot-pressing the mat into a membrane to form a composite separator.

8. The method of claim 7, further comprising heating the membrane was at a temperature under vacuum to prevent rehydration of activated MOF during process.

9. The method of claim 7, wherein the voltage is in a range of about 1-50 kV, the feeding rate is about 1 mL h⁻¹, and the fibers have diameters ranging from tens of micrometers to tens of nanometers, and the composite separator has a thickness that is collectively tuned by the feeding rate and operation time.

10. The method of claim 7, wherein the at least one MOF material comprises HKUST-1, MIL-100-Al, MIL-100-Cr, MIL-100-Fe, UiO-66, UiO-67, PCN series, MOF-808, MOF-505, MOF-74, or their combinations.

11. The method of claim 7, wherein the at least one polymer comprises silk fibroin, chitosan, gelatin, collagen, fibrinogen, polyvinylidene fluoride (PVDF), poly(vinylidene fluoride-co-hexafluoropropylene) (PVDF-HFP), poly(methyl methacrylate) (PMMA), polycaprolactone (PCL), polylactic acid (PLA), poly(vinyl alcohol) (PVA), polyvinylpyrrolidone (PVP), polyacrylonitrile (PAN), poly[imino(1,6-dioxohexamethylene) iminohexamethylene] (Nylon-6), polyethylene terephthalate (PET), polyurethane (PU), polyimide (PI), ethylene vinyl alcohol (EVOH), poly(ethylene oxide) (PEO) copolymers thereof, or their combinations.

12. The method of claim 1, wherein the at least one solvent comprises acetone, water, methanol, ethanol, acetic acid, dimethylformamide (DMF), acetone, water, methanol, ethanol, acetic acid, dimethylformamide (DMF), dimethylacetamide (DMAc), N-Methyl-2-pyrrolidone (NMP), tetrahydrofuran (THF), or their combinations.

13. An electrochemical device, comprising:
a positive electrode, a negative electrode, an electrolyte disposed between the positive and negative electrodes, and a separator disposed in the electrolyte,
wherein the electrolyte is an liquid electrolyte comprising a metal salt dissolved in a non-aqueous solvent; and
wherein the separator is the composite separator of claim 1.

14. The electrochemical device of claim 13, wherein the non-aqueous solvent comprises one or more of ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, and cyclic ether compounds including at least one of tetrahydrofuran, 2-methyltetrahydrofuran, 1,3-dioxolane and dioxane.

15. The electrochemical device of claim 13, wherein anions in the liquid electrolytes are spontaneously adsorbed by the at least one MOF material and immobilized within the pore channels, thereby liberating metal ions and leading to the metal ions transport with a metal ion transference number higher than that of a separator without the at least one MOF material.

16. The electrochemical device of claim 15, wherein the metal ions transference number is a ratio of a metal ion conductivity to an ionic conductivity, wherein the ionic conductivity is a total value of the metal ion conductivity and anionic conductivity.

17. The electrochemical device of claim 16, wherein the metal ion transference number of the liquid electrolytes in the composite separator is in a range of about 0.5-1.

18. The electrochemical device of claim 15, wherein the metal salt comprises one or more of a lithium salt, a sodium salt, a magnesium salt, a zinc salt, and an aluminum salt,
wherein the lithium salt comprises one or more of lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, and lithium chloride;
wherein the sodium salt comprises one or more of sodium trifluoromethanesulfonate, NaClO₄, NaPF₆, NaBF₄, NaTFSI (sodium(I) Bis(trifluoromethanesulfonyl)imide), and NaFSI (sodium(I) Bis(fluorosulfonyl)imide);
wherein the magnesium salt comprises one or more of magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), and Mg(FSI)₂ (magnesium(II) Bis(fluorosulfonyl)imide); and
wherein the zinc salt comprises one or more of zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide).

19. The electrochemical device of claim 17, wherein the electrochemical device is a lithium battery, a sodium battery, a magnesium battery, or a zinc metal battery,
wherein for the lithium battery, the positive electrode comprises one or more of LiCoO₂ (LCO), LiNiMnCoO₂ (NMC), lithium iron phosphate (LiFePO₄), lithium iron fluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide including LiNi_{0.8}Co_{0.15}Al_{0.05}O₂ or NCA, lithium vanadium oxide (LiV₂O₅), and Li₂MSiO₄ with M being composed of a ratio of Co, Fe, and/or Mn; and wherein the negative electrode comprises one or more of lithium metal (Li), graphite, hard or soft carbon, graphene, carbon nanotubes, titanium oxide including at least one Li₄Ti₅O₁₂ and TiO₂, silicon (Si), tin (Sn), germanium (Ge), silicon monoxide (SiO), silicon oxide (SiO₂), tin oxide (SnO₂), and transition metal oxide including at least one of Fe₂O₃, Fe₃O₄, Co₃O₄ and MnₓO_{y}; and
wherein the positive electrode comprises one or more of NaMnO₂, NaFePO₄ and Na₃V₂(PO₄)₃ for the sodium battery, one or more of TiSe₂, MgFePO₄F, MgCo₂O₄ and V₂O₅ for the magnesium battery, or one or more of γ-MnO₂, ZnMn₂O₄, and ZnMnO₂ for the zinc battery.
